(19) United States
(12) Patent Application Publication
(10) Pub. No.: US 2021/0086555 A1
(43) Pub. Date: Mar. 25, 2021

(54) AIR DISK BRAKE FOR COMMERCIAL VEHICLE

(71) Applicant: DOOSUNG SBTECH CO., LTD., Jeollabuk-do (KR)

(72) Inventors: Yeon Seung Kim, Jeollabuk-do (KR); Sung Hoon Kim, Jeollabuk-do (KR); Dae Yeon Hwang, Jeollabuk-do (KR)

(21) Appl. No.: 16/659,707

(22) Filed: Oct. 22, 2019

(30) Foreign Application Priority Data
Sep. 20, 2019 (KR) 10-2019-0115914

(51) Int. Cl. B60B 27/00; B60B 37/10; F16D 65/12; B60B 27/02

(52) U.S. Cl. CPC B60B 27/0052; B60B 37/10; B60T 1/065; B60B 27/02; F16D 65/123

(57) ABSTRACT

The present disclosure relates to an air disk brake for a commercial vehicle, and more particularly, to an air disk brake for a commercial vehicle in which a bearing housing and a wheel flange of a brake assembly coupled to a vehicle axle are formed with a separate structure for more convenient replacement of a disk rotor.

### CROSS-REFERENCE TO RELATED APPLICATION

This application claims priority of Korean Patent Application No. 10-2019-0115914, filed on Sep. 20, 2019, in the KIPO (Korean Intellectual Property Office), the disclosure of which is incorporated herein entirely by reference.

### BACKGROUND OF THE INVENTION

### Field of the Invention

The present disclosure relates to an air disk brake for a commercial vehicle, and more particularly, to an air disk brake for a commercial vehicle in which a bearing housing and a wheel flange of a brake assembly coupled to the vehicle axle are formed with a separate structure for more convenient replacement of a disk rotor.

### Description of the Related Art

Pneumatic brake system such as air brakes have long been used to control the driving and stop of vehicles due to being safe and easy to operate.

Particularly, air brakes have been generally used in large vehicles requiring a great braking power such as trucks or buses.

Vehicles have more sensitive and quicker brake operation due to the freight weight, and in practice, require air brakes having the powerful braking power.

Meanwhile, as shown in FIG. 1, in a conventional disk rotor, a hub is integrally formed with a bearing housing and a wheel flange. Thus, to replace the disk rotor, it is necessary to separate the hub and the bearing, and during this process, damage of the bearing and degradation and loss of grease unavoidably occur, and it is difficult to verify the assembly technique such as preload of the bearing.

### SUMMARY OF THE INVENTION

The present disclosure is directed to providing an air disk brake for a commercial vehicle in which a hub of a brake assembly coupled to a vehicle axle is formed in an assembly/disassembly structure with a wheel flange and a bearing housing, thereby replacing the brake disk more conveniently and preventing the damage of the bearing when separating the brake disk.

The object of the present disclosure is not limited to the above-mentioned object, and other objects not mentioned herein will be clearly understood by those having ordinary skill in the art from the following disclosure.

To achieve the above-described object, the present disclosure provides the following problem-solving approaches.

As an embodiment, there is provided an air disk brake for a commercial vehicle including: a hub fastened with a vehicle axle through a bearing set; an adapter inserted into the hub at one end of the hub; a brake disk detachably fastened with the adapter 28 by bolts; and a wheel flange detachably fastened with a plurality of lugs by bolts, wherein the lugs are formed in a circumferential direction at the other end of the hub.

In this case, the adapter includes a housing part into which one end of the hub is inserted and fitted, and a flange part is formed along a circumferential direction of the housing part, and the flange part has fastening holes to attach/detach to/from the brake disk without detaching the hub.

The wheel flange is fastened with the lugs by bolts when the brake disk is fastened with the adapter.

As another embodiment, there is provided an air disk brake for a commercial vehicle including: a hub fastened with a vehicle axle through a bearing set, and having a plurality of lugs with fastening holes on an outer side; a brake disk attachable/detachable to/from the hub when the hub is not separated from the vehicle axle; and a wheel flange attachable/detachable to/from the hub when the hub is not separated from the vehicle axle.

In this case, the brake disk is an annular shape with a space at a center, and includes a plurality of protrusions formed in an axial direction and spaced apart at a predetermined interval on an inner circumferential surface, and a lug part vertically formed toward a center from an end of the protrusions, and having fastening holes, the wheel flange includes a flange part 332 having fastening holes on an inner side, and the fastening holes are fastened to the lugs by bolts all at once.

As still another embodiment, there is provided an air disk brake for a commercial vehicle including: a hub fastened with a vehicle axle through a bearing set, and having a plurality of lugs with fastening holes on an outer side; a brake disk attachable/detachable to/from the hub when the hub is not separated from the vehicle axle; and a wheel flange attachable/detachable to/from the hub when the hub is not separated from the vehicle axle, wherein the brake disk is an annular shape with a space at a center, and includes a plurality of protrusions formed in an axial direction and spaced apart at a predetermined interval on an inner circumferential surface, and a lug part vertically formed toward a center from an end of the protrusions and having fastening holes, and the wheel flange includes a flange part having fastening holes on an inner side, and the fastening holes are fastened to the lugs by bolts all at once.

The air disk brake for a commercial vehicle according to the present disclosure is such that a bearing housing and a wheel flange are separately formed and bolt-coupled to each other and then coupled to a vehicle axle. Accordingly, after only the wheel flange is separated to replace the brake disk, the brake disk can be replaced, and thus there is no need to attach/detach the bearing, thereby preventing the degradation and loss of the bearing and preventing the durability reduction of the bearing.

Additionally, as opposed to the conventional integrated hub, according to the present disclosure, the wheel flange and the bearing housing are separately formed using different types of metals, which makes the vehicle lighter, and enhanced fuel efficiency of the vehicle can be expected.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is an exploded perspective view showing that a conventional hub integrally formed with a wheel flange and a bearing housing is coupled to a vehicle axle.

FIG. 2 is an exploded perspective view of an air disk brake for a commercial vehicle according to an embodiment of the present disclosure.

FIG. 3 is an assembled perspective view of an air disk brake for a commercial vehicle according to an embodiment of the present disclosure.

FIG. 4 is an assembled cross-sectional view of an air disk brake for a commercial vehicle according to an embodiment of the present disclosure.

FIG. 5 is an exploded perspective view of an air disk brake for a commercial vehicle according to another embodiment of the present disclosure.

FIG. 6 is an assembled cross-sectional view of the air disk brake for a commercial vehicle of FIG. 5.

FIG. 7 is an exploded perspective view of an air disk brake for a commercial vehicle according to still another embodiment of the present disclosure.

FIG. 8 is a cross-sectional view of an air disk brake for a commercial vehicle according to still another embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

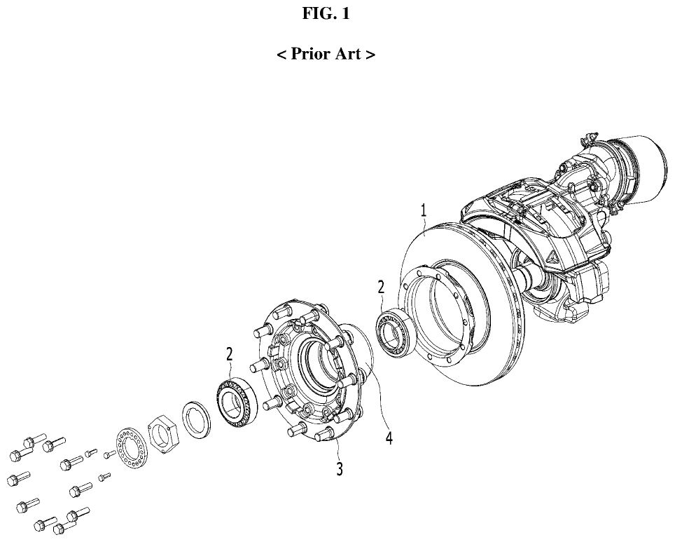

As shown in FIG. 1, a conventional hub integrally formed with a wheel flange and a bearing housing is coupled to a vehicle axle. To replace the disk rotor 1, inconveniently it is necessary to separate the integrated hub 4 and a plurality of bearings 2 arranged on the inner side of the hub 4. Additionally, special management of the bearing is required due to degradation and loss of the seal and grease of the bearing during replacement of the components, and this increases the cost for maintenance and management. In addition, because the conventional hub 4 is in integrated form, it is impossible to apply different types of materials. Accordingly, because heavier FCD based nodular cast iron is used, the total weight of the vehicle increases and the fuel efficiency reduces.

Hereinafter, as opposed to the conventional art, an air disk brake according to an embodiment of the present disclosure will be described.

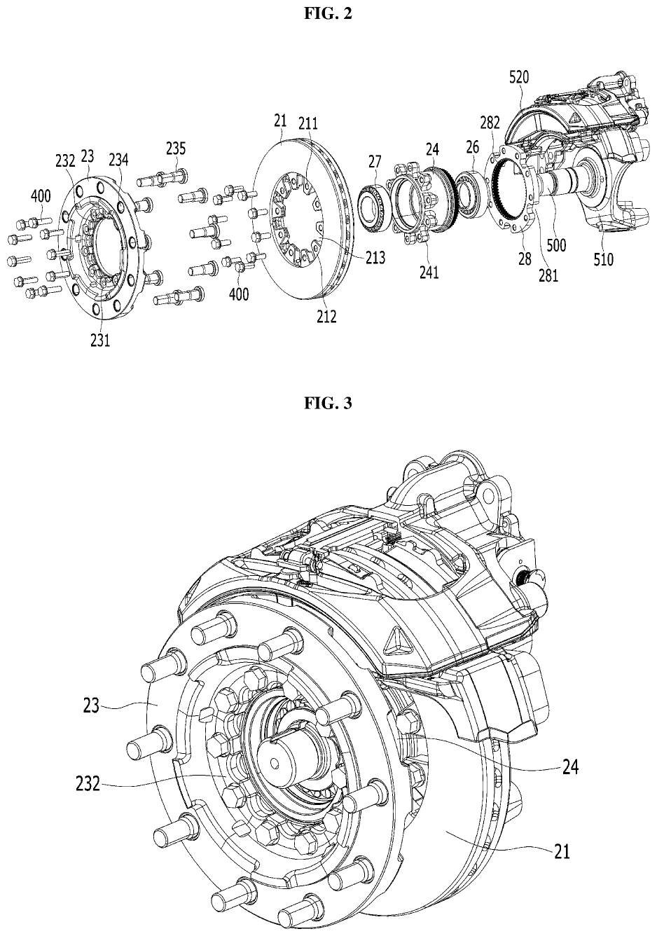

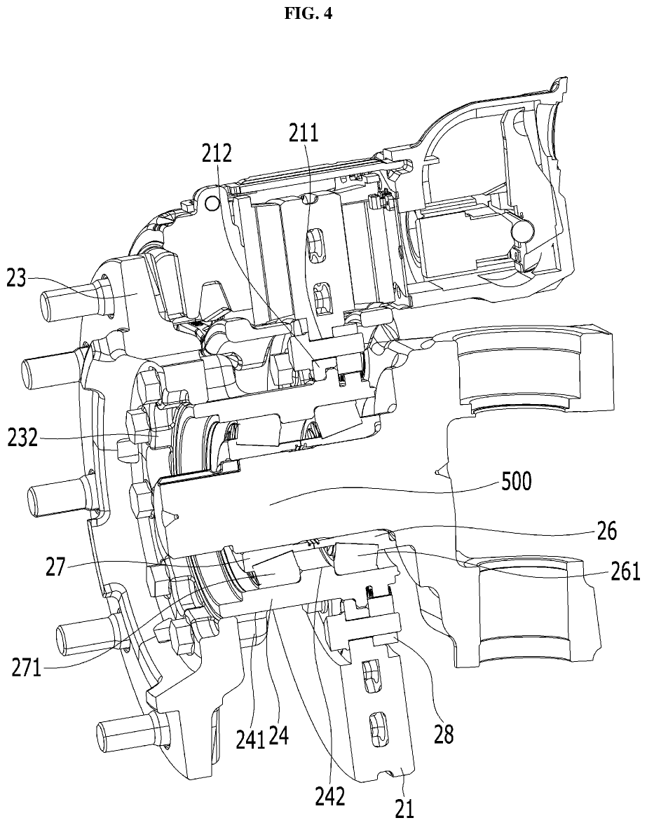

FIG. 2 is an exploded perspective view of an air disk brake for a commercial vehicle according to an embodiment of the present disclosure. FIG. 3 is an assembled perspective view of the air disk brake for a commercial vehicle according to an embodiment of the present disclosure. FIG. 4 is an assembled cross-sectional view of the air disk brake for a commercial vehicle according to an embodiment of the present disclosure.

As an embodiment of the present disclosure, describing with reference to FIGS. 2 to 4, there is provided an air disk brake for a commercial vehicle including: a hub 24 fastened with a vehicle axle through a bearing set 26, 27; an adapter 28 inserted into the hub 24 at one end of the hub; a brake disk 21 detachably fastened with the adapter 28 by bolts; and a wheel flange 23 detachably fastened with a plurality of lugs 241 by bolts, wherein the lugs 241 are formed in the circumferential direction at the other end of the hub 24.

As shown in FIG. 4, a central separation part 242 is formed on the inner side of the hub 24, and a first bearing 26 and a second bearing 27 are inserted into the hub 24 and tightly fixed to the central separation part 242. The first bearing 26 and the second bearing 27 preferably have protruding shapes 261, 271 to be fixed to the central separation part 242.

In this case, the adapter 28 includes a housing part 282 into which one end of the hub 24 is inserted and fitted, and a flange part 232 is vertically formed along the circumferential direction of the housing part 282, and has fastening holes to attach/detach to/from the brake disk 21 without detaching the hub 24.

The adapter 28 is fixedly inserted into the hub 24, and integrally rotates with the hub 24. Grooves 281 are formed at a predetermined interval on the outer surface of the housing part 282 of the adapter 28.

Meanwhile, the shape of the adapter 28 is shown in FIG. 2. The housing part 282 is formed on the inner side of the adapter 28, and the housing part has a teeth shape and is fitted with the hub 24, and the shape is not limited to the teeth shape if it can accomplish various inter-coupling.

Additionally, part of the flange has spaces 281 at a predetermined interval to produce a weight reduction effect.

The wheel flange 23 is fastened with the lugs 241 by bolts with the brake disk 21 being fastened with the adapter 28.

The brake disk 21 is an annular shape with a space at the center, and protrusions 212 having fastening grooves 211 are repeatedly formed and spaced apart at a predetermined interval on the inner surface. The gap between the protrusions 212 forms a space 213, and before mounting, when the brake disk is inserted and fastened with the adapter 28 through the lugs 241 of the hub, the brake disk passes without interference of the lugs 241 of the hub through the space 213.

After the brake disk 21 is fastened with the adapter 28, the wheel flange 23 is fastened with the lugs 241 of the hub by bolts.

The wheel flange 23 is an annular shape with a space at the center, and includes the flange part 232 having the fastening grooves 231 for fastening with the lugs 241 on the inner side.

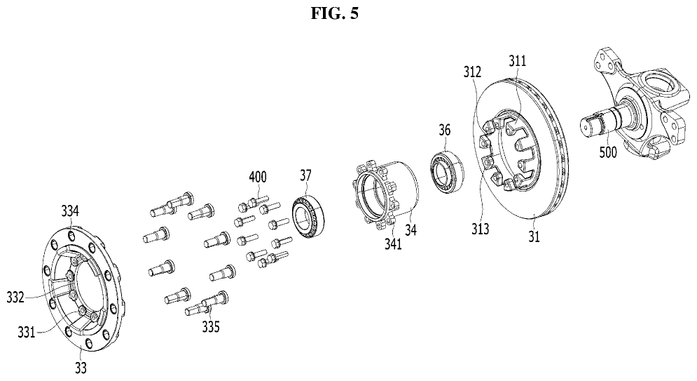

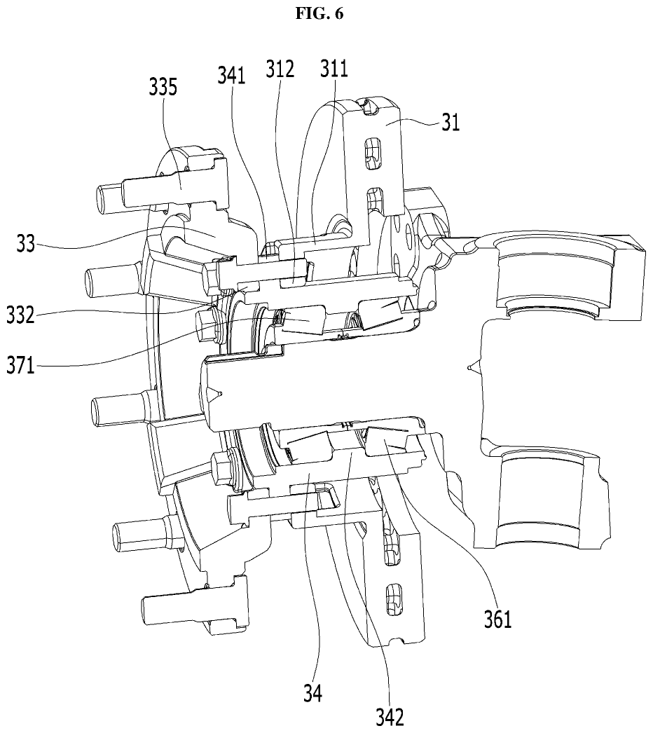

FIG. 5 is an exploded perspective view of an air disk brake for a commercial vehicle according to another embodiment of the present disclosure. FIG. 6 is an assembled cross-sectional view of the air disk brake for a commercial vehicle according to another embodiment of the present disclosure.

As another embodiment according to the present disclosure, there is provided an air disk brake for a commercial vehicle including: a hub 34 fastened with a vehicle axle through a bearing set 36, 37 and including a plurality of lugs 341 having fastening holes on the outer side; a brake disk 31 that can be attached and detached to/from the hub 34 when the hub 34 is not separated from the vehicle axle; and a wheel flange 33 that can be attached and detached to/from the hub 34 when the hub 34 is not separated from the vehicle axis.

In this case, the brake disk 31 is an annular shape with a space at the center, and includes a plurality of protrusions 311 formed in the axial direction and spaced apart at a predetermined interval on the inner circumferential surface, and a lug part 312 formed vertically toward the center from the end of the protrusions 311 and having fastening holes 313, and the wheel flange 33 includes a flange part 332 having fastening holes 331 on the inner side, and the fastening holes 313, 331 are fastened into the lugs by bolts all at once.

The hub 34 is fixed and coupled to the vehicle axle through the bearing set 36, 37, and in this state, the brake disk 31 is inserted and disposed outside. The protrusions 311 are spaced apart at a predetermined interval, and a space is formed in the gap between the protrusions 311. When the brake disk 31 is inserted into the hub, the brake disk 31 is inserted without interference of the lugs 341 through this space.

As shown in FIG. 6, the present disclosure features that one surface of the lug part 312 of the inserted brake disk 31 keep in contact with the inner surface of the lugs 341 of the hub 34, and in this state, the flange part 332 of the wheel flange 33 comes into contact with the outer surface of the lugs 341 of the hub 34, and they are fastened by bolts all at once.

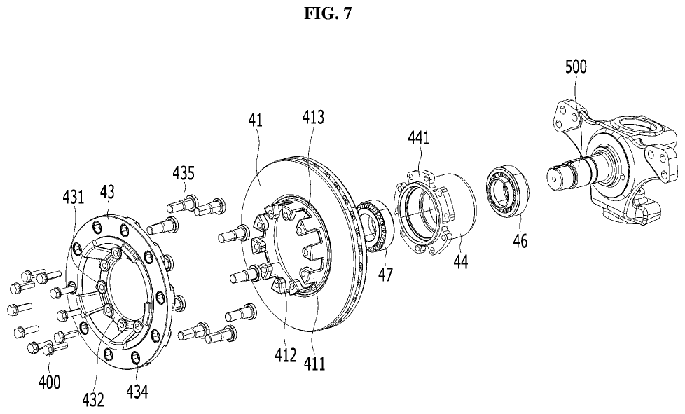

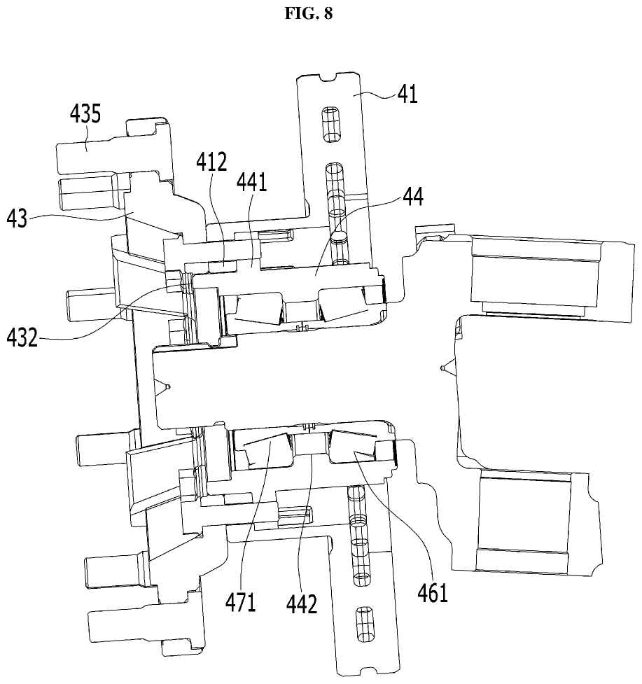

FIG. 7 is an exploded perspective view of an air disk brake for a commercial vehicle according to still another embodiment of the present disclosure. FIG. 8 is an assembled cross-sectional view of the air disk brake for a commercial vehicle according to still another embodiment of the present disclosure.

Still another embodiment of the present disclosure provides an air disk brake for a commercial vehicle including a hub 44 fastened with a vehicle axle through a bearing set 46, 47 and having a plurality of lugs 441 with fastening holes on the outer side, a brake disk 41 that can be attached/detached to/from the hub 44 when the hub 44 is not separated from the vehicle axle, and a wheel flange 43 that can be attached/detached to/from the hub 44 when the hub 44 is not separated from the vehicle axle.

In this case, the brake disk 41 is an annular shape with a space at the center, and includes a plurality of protrusions 411 formed in an axial direction and spaced apart at a predetermined interval on the inner circumferential surface, and a lug part 412 vertically formed toward the center from the end of the protrusions 411 and having fastening holes 413, and the wheel flange 43 includes a flange part 432 having fastening holes 431 on the inner side, and the fastening holes 413, 431 are fastened to the lugs with bolts all at once.

The hub 44 is fixed and coupled to the vehicle axle through the bearing set 46, 47, and in this state, the brake disk 41 is inserted and disposed outside. The protrusions 411 are spaced apart at a predetermined interval, and a space is formed in the gap between the protrusions 411.

The present disclosure features that one surface of the lug part 412 of the inserted brake disk 41 keeps in contact with the outer surface of the lugs 441 of the hub 44, and in this state, the flange part 432 of the wheel flange 43 comes into contact with the other surface of the lug part 412 of the brake disk 41, and they are fastened by bolts all at once.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An air disk brake for a commercial vehicle, comprising:
a hub fastened with a vehicle axle through a bearing set;
an adapter inserted into the hub at one end of the hub;
a brake disk detachably fastened with the adapter by bolts; and
a wheel flange detachably fastened with a plurality of lugs by bolts,
wherein the lugs are formed in a circumferential direction at the other end of the hub.

2. The air disk brake for a commercial vehicle of claim 1, wherein the adapter comprises:
a housing part into which one end of the hub is inserted and fitted; and
a flange part is formed along a circumferential direction of the housing part,
wherein the flange part has fastening holes to attach/detach to/from the brake disk without detaching the hub.

3. The air disk brake for a commercial vehicle of claim 1, wherein the wheel flange is fastened with the lugs by bolts when the brake disk is fastened with the adapter.

4. An air disk brake for a commercial vehicle, comprising:
a hub fastened with a vehicle axle through a bearing set, and having a plurality of lugs with fastening holes on an outer side;
a brake disk attachable/detachable to/from the hub when the hub is not separated from the vehicle axle; and
a wheel flange attachable/detachable to/from the hub when the hub is not separated from the vehicle axle,
wherein the brake disk is an annular shape with a space at a center, the brake disk comprises:
a plurality of protrusions formed in an axial direction and spaced apart at a predetermined interval on an inner circumferential surface; and
a lug part vertically formed toward a center from an end of the protrusions, and having fastening holes,
wherein the wheel flange includes a flange part having fastening holes on an inner side,
wherein the fastening holes are fastened to the lugs by bolts all at once.

5. An air disk brake for a commercial vehicle, comprising:
a hub fastened with a vehicle axle through a bearing set, and having a plurality of lugs with fastening holes on an outer side;
a brake disk attachable/detachable to/from the hub; and
a wheel flange attachable/detachable to/from the hub, the wheel flange comprises a flange part having fastening holes on an inner side,
wherein the brake disk is an annular shape with a space at a center, the brake disk comprises:
a plurality of protrusions formed in an axial direction and spaced apart at a predetermined interval on an inner circumferential surface; and
a lug part vertically formed toward a center from an end of the protrusions and having fastening holes.

6. The air disk brake for a commercial vehicle of claim 5, wherein the fastening holes are fastened to the lugs by bolts all at once.
